(19) United States
(12) Patent Application Publication
(10) Pub. No.: US 2026/0046421 A1
(43) Pub. Date: Feb. 12, 2026

(54) HARDWARE VIDEO ENCODER ARCHITECTURE FOR MULTIROW PARALLEL ENCODING

(71) Applicant: NVIDIA Corporation, Santa Clara, CA (US)

(72) Inventors: Jianjun CHEN, Shanghai (CN); Xi HE, Shanghai (CN); Wei FENG, Shanghai (CN); Gongyu ZHOU, Shanghai (CN); Yongmao TANG, Shanghai (CN); Zejun HU, Shanghai (CN)

(21) Appl. No.: 18/801,104

(22) Filed: Aug. 12, 2024

(51) Int. Cl. H04N 19/176; H04N 19/11; H04N 19/117; H04N 19/124; H04N 19/147; H04N 19/156; H04N 19/513

(52) U.S. Cl. CPC H04N 19/176; H04N 19/11; H04N 19/117; H04N 19/124; H04N 19/147; H04N 19/156; H04N 19/513

(57) ABSTRACT

Various embodiments include techniques for parallel encoding of multiple rows of a media frame. The disclosed video encoder includes multiple controllers, where each controller encodes components, or blocks, included in a different row of a media frame. Each of the controllers encodes the respective blocks of the different rows by sending commands and data to different encoding resources that each perform different encoding functions. The controllers have concurrent and independent access to the encoding resources. As a result, the controllers can access any encoding resource to perform encoding functions without regard to what other encoding resources are performing encoding functions for other controllers. As a result, utilization of encoding resources is increased, and encoding performance is improved, relative to conventional techniques.

### BACKGROUND

### Field of the Various Embodiments

Various embodiments relate generally to video encoding architectures and, more specifically, to a hardware video encoder architecture for multirow parallel encoding.

### Description of the Related Art

When streaming live or prerecorded video, a first computing system, such as a server, a data center, a cloud storage system, and/or the like, transmits a video stream to a second computing system, such as a smart phone, a tablet computer, a laptop computer, and/or the like. Transmitting video streams between computing systems can consume a significant amount of network bandwidth, thereby reducing network bandwidth available for other uses. Therefore, a goal of computing systems that transmit video streams is to compress and encode video streams prior to transmission without substantially reducing video quality. Computing systems that receive such video streams decompress and decode the video streams prior to displaying the video streams on one or more display devices.

When compressing and encoding a video stream, a computing system typically includes a hardware video encoder that divides each media frame included in the video stream into blocks, where each block includes a group of adjacent pixels of the media frame. Each block of adjacent pixels can be an 8×8 block of pixels, a 16×16 block of pixels, and/or the like. Depending on the video format used for encoding, these blocks are referred to as macroblocks, coding tree units (CTUs), and/or the like. The video encoder typically encodes the blocks as a set of rows, where the blocks of each row are encoded sequentially from left to right, and the rows are encoded from top to bottom.

Typically, video encoders divide each block into multiple partitions. To achieve higher encoding quality when encoding the pixels in each partition, the video encoder can access data, such as motion vector data, from blocks in similar locations of the prior media frame to generate a prediction, referred to as an interframe prediction. The video encoder can also access neighboring pixels within the same media frame to generate a prediction, referred to as an intraframe prediction. These neighboring pixels can include pixels from previously encoded partitions, such as partitions to the left and/or partitions above the current partitions. In this manner, the video encoder bases the prediction for a current partition on neighboring pixels from adjacent partitions. As a result, video encoding generally involves sequential encoding of partitions from left to right and top to bottom in each media frame of a video stream.

One problem with this approach for video encoding, is that, for hardware encoders, sequential video encoding can result in significant wait times for various hardware components in the hardware encoder. The process of encoding partitions sequentially, therefore, leads to underutilization and reduced efficiency of CPUs, GPUs, and/or hardware video encoders. Further, parallel encoding of partitions is not possible because of the potential dependency of each partition on pixels in partitions to the left and/or above the current partition. As a result, video encoding cannot take advantage of the parallel processing capabilities of modern central processing units (CPUs) and graphics processing units (GPUs).

One approach to solving this problem is to include multiple hardware video encoders in the computing system. With this approach, a first video encoder can encode a first video stream, a second video encoder can encode a second video stream, and so on. One disadvantage with this approach is that additional hardware video encoders can result in doubling, tripling, or more of the integrated circuit surface area and power consumption utilized for encoding video streams. Another disadvantage with this approach is that, although multiple video streams can be encoded in parallel, the encoding speed of each individual video stream is not enhanced, due to interframe dependencies that prevent parallel encoding. Further, this approach does not resolve efficiency issues related to intraframe dependencies caused by dependencies between partitions in a single encoder.

As the foregoing illustrates, what is needed in the art are more effective techniques for encoding video streams in a computing system.

### SUMMARY

Various embodiments of the present disclosure set forth a computer-implemented method for parallel encoding of multiple block rows in a media frame. The method includes encoding, by a first controller, a first plurality of blocks included in a first row of a media frame. The method further includes encoding, by a second controller, a second plurality of blocks included in a second row of the media frame.

The method further includes accessing, by the second controller, a first hardware computational resource to perform a first video encoding function. With the disclosed method, the first hardware computational resource is concurrently accessible by the first controller and the second controller.

Other embodiments include, without limitation, a system that implements one or more aspects of the disclosed techniques, and one or more computer readable media including instructions for performing one or more aspects of the disclosed techniques, as well as a method for performing one or more aspects of the disclosed techniques.

At least one technical advantage of the disclosed techniques relative to the prior art is that, with the disclosed techniques, a video encoder includes multiple row control units that encode multiple rows of blocks in the media frame in parallel. Further, various other hardware computational resources included in the video encoder are available in parallel to the row control units. Therefore, each row control unit can access any idle functional units of the video encoder without waiting for other row control units to reach a particular stage of the video encoding process. As a result, parallel processing of block rows and utilization of other functional units of the video encoder can be enhanced relative to prior conventional approaches. These advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system configured to implement one or more aspects of the various embodiments;

FIG. 2 is a block diagram of a parallel processing unit (PPU) included in the accelerator processing subsystem of FIG. 1, according to various embodiments;

FIG. 3 is a block diagram of a general processing cluster (GPC) included in the parallel processing unit (PPU) of FIG. 2, according to various embodiments;

FIG. 4 is a block diagram of a video encoder configured to encode multiple block rows in parallel for the computing system of FIGS. 1-3, according to various embodiments;

FIG. 5 illustrates a functional view of a video encoder that can encode a media frame for the computing system of FIGS. 1-4, according to various embodiments;

FIG. 6 is a block diagram of a video encoder configured for sequential video encoding that can be implemented in the computing system of FIG. 1, according to various embodiments;

FIGS. 7A-B illustrate how blocks of a media frame are encoded by the video encoders of FIGS. 4-6, according to various embodiments;

FIG. 8 is a flow diagram of method steps for parallel encoding of multiple block rows in the computing system of FIGS. 1-7B, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

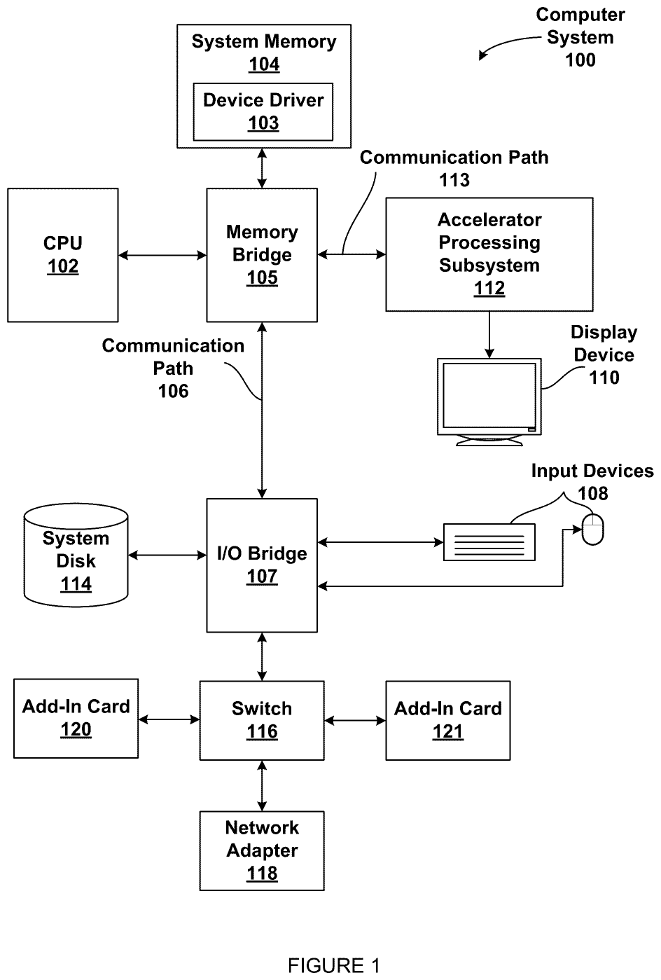

FIG. 1 is a block diagram of a computing system 100 configured to implement one or more aspects of the various embodiments. As shown, computing system 100 includes, without limitation, a central processing unit (CPU) 102 and a system memory 104 coupled to an accelerator processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. In some examples, input devices 108 are employed to verify the identities of one or more users in order to permit access of computing system 100 to authorized users and deny access of computing system 100 to unauthorized users. Switch 116 is configured to provide connections between I/O bridge 107 and other components of the computing system 100, such as a network adapter 118 and various add-in cards 120 and 121. In some examples, network adapter 118 serves as the primary or exclusive input device to receive input data for processing via the disclosed techniques.

As also shown, I/O bridge 107 is coupled to a system disk 114 that may be configured to store content and applications and data for use by CPU 102 and accelerator processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, Peripheral Component Interconnect Express (PCIe), HyperTransport, or any other bus or point-to-point communication protocol known in the art.

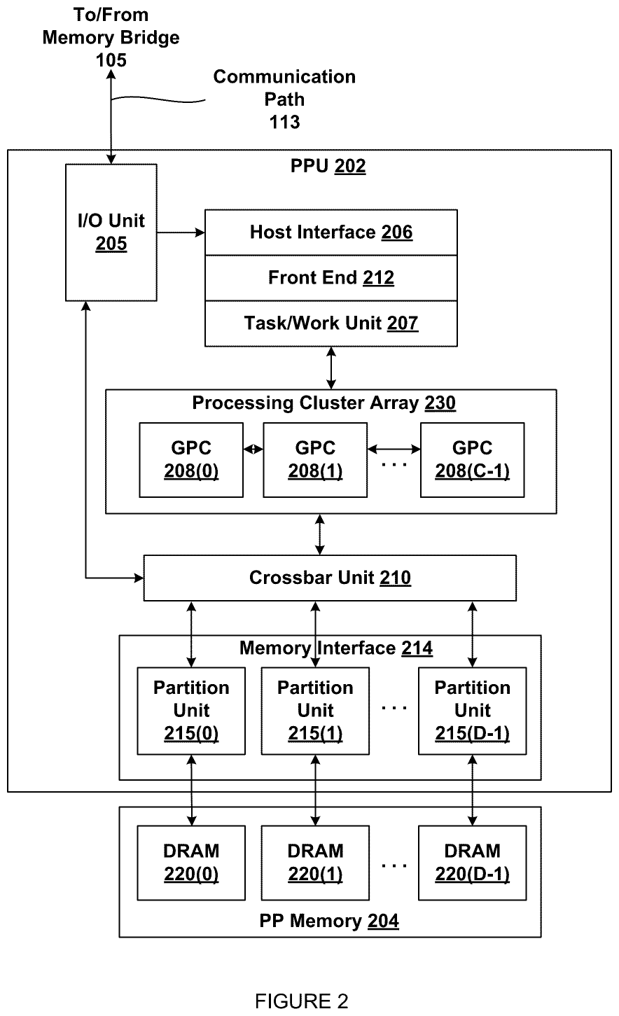

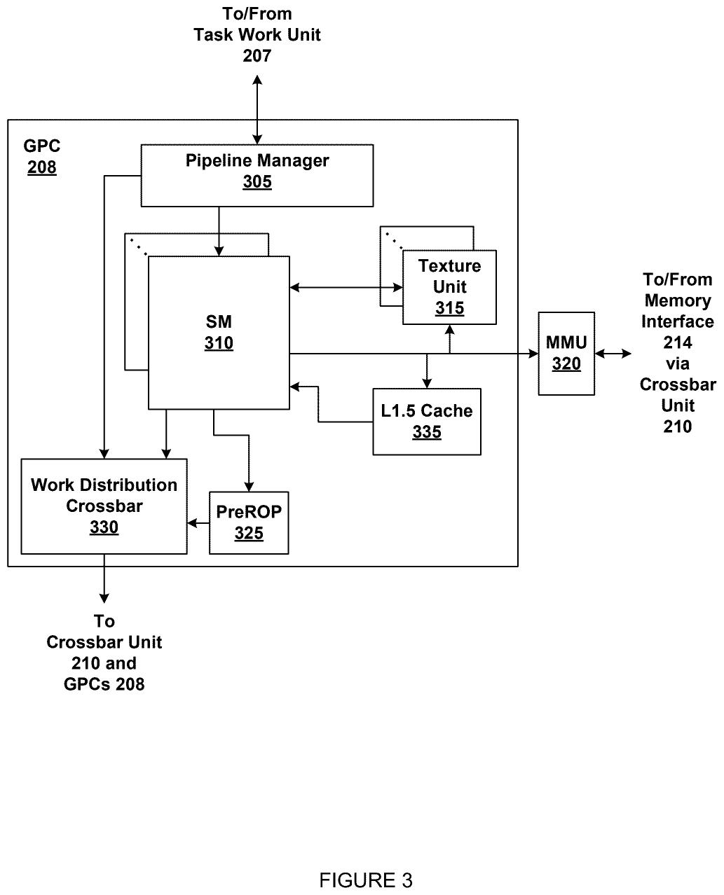

In some embodiments, accelerator processing subsystem 112 comprises a graphics subsystem that delivers pixels to a display device 110 that may be any conventional cathode ray tube, liquid crystal display, light-emitting diode display, or the like. In such embodiments, the accelerator processing subsystem 112 incorporates circuitry optimized for graphics and video processing, including, for example, video output circuitry. As described in greater detail below in FIG. 2, such circuitry may be incorporated across one or more accelerators included within accelerator processing subsystem 112. An accelerator includes any one or more processing units that can execute instructions such as a central processing unit (CPU), a parallel processing unit (PPU) of FIGS. 2-3, a graphics processing unit (GPU), a direct memory access (DMA) unit, an intelligence processing unit (IPU), neural processing unit (NAU), tensor processing unit (TPU), neural network processor (NNP), a data processing unit (DPU), a vision processing unit (VPU), an application specific integrated circuit (ASIC), a field-programmable gate array (FPGA), and/or the like.

In some embodiments, accelerator processing subsystem 112 includes two processors, referred to herein as a primary processor (normally a CPU) and a secondary processor. Typically, the primary processor is a CPU and the secondary processor is a GPU. Additionally or alternatively, each of the primary processor and the secondary processor may be any one or more of the types of accelerators disclosed herein, in any technically feasible combination. The secondary processor receives secure commands from the primary processor via a communication path that is not secured. The secondary processor accesses a memory and/or other storage system, such as such as system memory 104, Compute eXpress Link (CXL) memory expanders, memory managed disk storage, on-chip memory, and/or the like. The secondary processor accesses this memory and/or other storage system across an insecure connection. The primary processor and the secondary processor may communicate with one another via a GPU-to-GPU communications channel, such as Nvidia Link (NVLink). Further, the primary processor and the secondary processor may communicate with one another via network adapter 118. In general, the distinction between an insecure communication path and a secure communication path is application dependent. A particular application program generally considers communications within a die or package to be secure. Communications of unencrypted data over a standard communications channel, such as PCIe, are considered to be unsecure.

In some embodiments, the accelerator processing subsystem 112 incorporates circuitry optimized for general purpose and/or compute processing. Again, such circuitry may be incorporated across one or more accelerators included within accelerator processing subsystem 112 that are configured to perform such general purpose and/or compute operations. In yet other embodiments, the one or more accelerators included within accelerator processing subsystem 112 may be configured to perform graphics processing, general purpose processing, and compute processing operations. System memory 104 includes at least one device driver 103 configured to manage the processing operations of the one or more accelerators within accelerator processing subsystem 112.

In various embodiments, accelerator processing subsystem 112 may be integrated with one or more other the other elements of FIG. 1 to form a single system. For example, accelerator processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of accelerator processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, accelerator processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the accelerator processing subsystem 112 of FIG. 1, according to various embodiments. Although FIG. 2 depicts one PPU 202, as indicated above, accelerator processing subsystem 112 may include any number of PPUs 202. Further, the PPU 202 of FIG. 2 is one example of an accelerator included in accelerator processing subsystem 112 of FIG. 1. Alternative accelerators include, without limitation, CPUs, GPUs, DMA units, IPUs, NPUs, TPUs, NNPs, DPUs, VPUs, ASICs, FPGAs, and/or the like. The techniques disclosed in FIGS. 2-3 with respect to PPU 202 apply equally to any type of accelerator(s) included within accelerator processing subsystem 112, in any combination. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computing system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. Additionally or alternatively, processors and/or accelerators other than CPU 102 may write one or more streams of commands for PPU 202 to a data structure. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computing system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computing system 100 may be varied. In some embodiments, accelerator processing subsystem 112, which includes at least one PPU 202, is implemented as an add-in card that can be inserted into an expansion slot of computing system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≥1. Each partition unit 215 is coupled to one or more dynamic random access memories (DRAMs) 220 residing within PP memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPC 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity, and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within accelerator processing subsystem 112, or another accelerator processing subsystem 112 within computing system 100.

As noted above, any number of PPUs 202 may be included in an accelerator processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

FIG. 3 is a block diagram of a general processing cluster (GPC) 208 included in the parallel processing unit (PPU) 202 of FIG. 2, according to various embodiments. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310. In various embodiments, a software application written in the compute unified device architecture (CUDA) programming language describes the behavior and operation of threads executing on GPC 208, including any of the above-described behaviors and operations. A given processing task may be specified in a CUDA program such that the SM 310 may be configured to perform and/or manage general-purpose compute operations.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), PP memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the various embodiments of the present disclosure.

Please note, as used herein, references to shared memory may include any one or more technically feasible memories, including, without limitation, a local memory shared by one or more SMs 310, or a memory accessible via the memory interface 214, such as a cache memory, PP memory 204, or system memory 104. Please also note, as used herein, references to cache memory may include any one or more technically feasible memories, including, without limitation, an L1 cache, an L1.5 cache, and the L2 caches.

### Video Encoder Architecture for Multirow Parallel Encoding

Various embodiments include techniques for parallel encoding of multiple block rows by a video encoder included in a computing system. As described herein, an improved video encoder processes block rows of a media (e.g., video, audio, and/or the like) frame as parallel units. The video encoder assigns and schedules each hardware control unit in a set of multiple control unit to encode a different block row. For a video encoder with N control units, the row control units can encode N block rows concurrently. The video encoder operates such that a preceding block row is encoded before a subsequent block row at least to the point where the block currently being encoded for the subsequent block row can access the needed information for neighboring pixels included in blocks of the preceding block row. This approach allows the row control unit for the subsequent block row to utilize the encoding information from the top neighbor block row being encoded by a different row control unit. Within a given block, the row control unit can encode the various partitions of the block sequentially. In this manner, the video encoder enables access by the row control units to neighbor partition information, thereby achieving high video encoding quality.

The row control units performing parallel encoding of block rows share other hardware computational resources of the video encoder including motion estimation, intra search, rate distortion optimization, reconstruction, and filtering. As a result, if one row control unit is waiting internally due to partition dependencies, and therefore does not utilize other hardware computational resources, then other row control units encoding partitions for other block rows can utilize these other hardware computational resources. This parallelism across multiple block rows can better leverage these other hardware computational resources, thereby enhancing utilization and efficiency of the hardware computational resources of the video encoder. Further, the performance of this approach can by further enhanced by adding more row control units in order to encode more block rows in parallel. In this manner, the performance increase with the disclosed techniques is scalable as a function of the number of row control units. At the same time, encoding multiple block rows in parallel can achieve almost the same quality as sequential encoding, but with significantly increased performance.

With this approach, each row control unit included in a hardware video encoder is responsible for encoding a different block row of a media frame included in a video stream. The multiple row control units manage the parallelism and synchronization between the block rows being concurrently encoded. Further, the multiple row control units manage access to various other hardware computational resources included in the video encoder. These hardware computational resources are capable of handling computation requests from different row control units that are encoding partitions across various block rows.

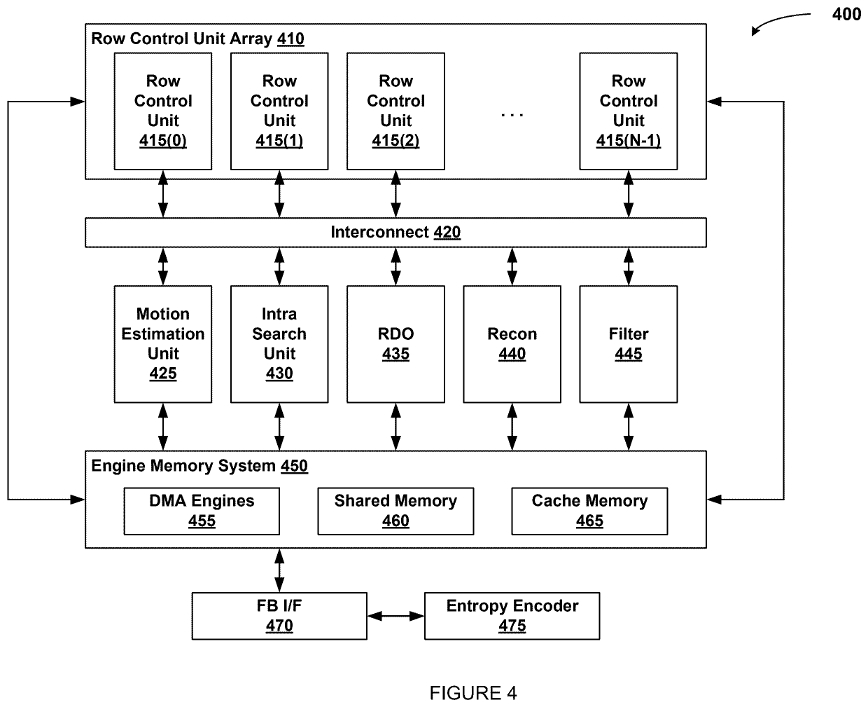

FIG. 4 is a block diagram of a video encoder 400 configured to encode multiple block rows in parallel for the computing system 100 of FIGS. 1-3, according to various embodiments. As shown, video encoder 400 includes, without limitation, a row control unit array 410, an interconnect 420, a motion estimation unit 425, an intra search unit 430, a rate-distortion optimization unit (RDO) 435, a reconstruction unit (recon) 440, a filter 445, an engine memory system 450, a frame buffer interface (FB I/F) 470, and an entropy encoder 475. Row control unit array 410 includes, without limitation, N row control units 415(0), 415(1), 415(2), . . . , 415(N−1), also referred to as row controllers or, simply, controllers. Engine memory system 450 includes various memory subsystems including, without limitation, direct memory access engines 455, shared memory 460, and cache memory 465. The components of engine memory system 450 can access frame buffer memory (not shown) via frame buffer interface 470. The frame buffer memory can be a special purpose memory for storing image data or can be a portion of another memory including, without limitation, PP memory 204, system memory 104, and/or the like.

Each row control unit 415(0), 415(1), 415(2), . . . , 415(N−1) included in row control unit array 410 encodes a different block row in a group of N block rows. For example, row control unit 415(0) can encode a first block row, row control unit 415(1) can encode a second block row, row control unit 415(2) can encode a third block row, and so on, such that row control unit 415(N−1) can encode an n^{th} block row. Each row control unit 415(0), 415(1), 415(2), . . . , 415(N−1) has concurrent access to various functional units of video encoder 400 via interconnect 420. These other functional units include, without limitation, motion estimation unit 425, intra search unit 430, rate-distortion optimization unit 435, reconstruction unit 440, and filter 445. The row control units 415(0), 415(1), 415(2), . . . , 415(N−1) included in row control unit array 410 additionally communicate over one or more communication channels to direct memory access engines 455, shared memory 460, and cache memory 465 included in engine memory system 450. To access the various functional units of video encoder 400, the row control units 415(0), 415(1), 415(2), . . . , 415(N−1) transmit commands and data pertaining to the current block being encoded to the appropriate functional unit via interconnect 420.

With this concurrent access to these functional units, delay sustained by a particular row control unit 415 does not materially impact access to functional units by other row control units 415. For example, when encoding a block for one block row, row control unit 415(0) may be stalled from accessing another functional unit, such as motion estimation unit 425 or intra search unit 430, until the requisite input data is received by row control unit 415(0). However, while row control unit 415(0) is delayed pending the receipt of the input data, motion estimation unit 425 and intra search unit 430 are not blocked from being accessed by other row control units 415(1), 415(2), . . . , 415(N−1) that are encoding other blocks for other block rows. Instead, other row control units 415(1), 415(2), . . . , 415(N−1) can access motion estimation unit 425, intra search unit 430, and/or other functional units as needed.

Interconnect 420 can be any suitable connection bus, mesh, network, and/or the like for transmitting data between row control units 415(0), 415(1), 415(2), . . . , 415(N−1) and other functional units including, without limitation, motion estimation unit 425, intra search unit 430, rate-distortion optimization unit 435, reconstruction unit 440, and filter 445.

Motion estimation unit 425 performs motion estimation and/or motion compensation for the blocks included in the block rows encoded by row control units 415(0), 415(1), 415(2), . . . , 415(N−1). More specifically, motion estimation unit 425 performs motion estimation and/or motion compensation in response to receiving a request from a row control unit 415 to process a specified block. Motion estimation unit 425 performs motion estimation and/or motion compensation to generate an interframe candidate for the specified block based on temporal redundancy between media frames. Motion estimation unit 425 generates a motion vector for the current block that is predictive of the block of the current media frame from the corresponding block of a reference media frame. Video encoder 400 can use the motion vector as an interframe candidate. Based on the motion vector, motion estimation unit 425 generates motion compensated pixels for the interframe candidate. Motion estimation unit 425 transmits the motion compensated pixels for the interframe candidate to the requesting row control unit 415.

Intra search unit 430 generates an intraframe candidate for the blocks included in the block rows encoded by row control units 415(0), 415(1), 415(2), . . . , 415(N−1). More specifically, intra search unit 430 performs intra estimation and/or intra prediction in response to receiving a request from a row control unit 415 to process a specified block. Intra search unit 430 performs intra estimation and/or intra prediction to generate an intraframe candidate for the specified block based on spatial redundancy within a media frame.

To perform intra estimation, intra search unit 430 selects an intra prediction mode based on the current pixels in the current media frame and on the neighboring pixels of the reconstructed current media frame. In some embodiments, intra search unit 430 can select the intra prediction mode that best predicts the pixels of the current block. Intra search unit 430 can select the intra prediction mode that results in the lowest rate-distortion cost value based on the sum of square errors (SSE) distortion for the current block as determined by rate-distortion optimization unit 435. The number and type of available prediction modes can vary based on the block size. For example, the number and type of available prediction modes can be different among 4×4 pixel blocks, 8×8 pixel blocks, 16×16 pixel blocks, 32×32 pixel blocks, and/or the like. In that regard, intra search unit 430 can select different prediction modes for each of the possible block sizes based on what prediction mode results in lowest rate-distortion cost value determined by rate-distortion optimization unit 435 for the respective block size. Further, intra search unit 430 can select different prediction modes for the luma values in the block versus the chroma samples in the block. In some embodiments, the prediction mode determines the order that the pixels in the current block are scanned to generate the predicted intraframe candidate. For example, the prediction mode can specify vertical scanning, horizontal scanning, diagonal down-left scanning, diagonal down-right scanning, vertical left scanning, vertical right scanning, horizontal down scanning, horizontal up scanning, and/or the like.

To perform intra prediction, intra search unit 430 generates an intraframe candidate based on the selected intra prediction mode. Intra search unit 430 scans the pixel values in the current block in the order specified by the selected intra prediction mode. For each scanned pixel, intra search unit 430 determines a predicted pixel value based on differences between the pixel value and the pixel values of pixels that neighbor the pixel. From the predicted pixel values, intra search unit 430 generates the intraframe candidate. Intra search unit 430 transmits the intraframe candidate to the requesting row control unit 415.

Rate-distortion optimization unit 435 performs rate-distortion optimization for the blocks included in the block rows encoded by row control units 415(0), 415(1), 415(2), . . . , 415(N−1). More specifically, rate-distortion optimization unit 435 performs rate-distortion optimization in response to receiving a request from a row control unit 415 to process a specified block. Rate-distortion optimization unit 435 selects a winning candidate for a block between the interframe candidate generated by motion estimation unit 425 for that block and the intraframe candidate generated by intra search unit 430 for that block. Rate-distortion optimization unit 435 receives the interframe candidate and the intraframe candidate from the requesting row control unit 415. Rate-distortion optimization unit 435 further receives the reconstructed pixels of the block in the reconstructed current media frame from the requesting row control unit 415, as generated by reconstruction unit 440. Based on the reconstructed pixels of the block in the reconstructed current media frame, rate-distortion optimization unit 435 determines a rate-distortion cost value based on the sum of square errors (SSE) distortion for the current block. Rate-distortion optimization unit 435 selects the winning candidate based at least in part on the rate-distortion cost value for the current block as determined by rate-distortion optimization unit 435. In some embodiments, rate-distortion optimization unit 435 further performs a transformation operation and/or a quantization operation on the block as part of the encoding process. Rate-distortion optimization unit 435 transmits the winning candidate to the requesting row control unit 415. Rate-distortion optimization unit 435 can further transmit the transformed and/or quantized block of the winning candidate to the requesting row control unit 415.

Reconstruction unit 440 performs image reconstruction for the blocks included in the block rows encoded by row control units 415(0), 415(1), 415(2), . . . , 415(N−1). More specifically, reconstruction unit 440 performs image reconstruction in response to receiving a request from a row control unit 415 to process a specified block. Reconstruction unit 440 performs image reconstruction on frequency coefficients that have previously been transformed and quantized during the encoding process. Reconstruction unit 440 performs an inverse quantization function to reverse the quantization previously performed on the block. Reconstruction unit 440 performs an inverse transformation function to reverse the transformation previously performed on the block. In so doing, reconstruction unit 440 generates reconstructed residue. Reconstruction unit 440 sums the reconstructed residue with the winning candidate generated by rate-distortion optimization unit 435 and received from the requesting row control unit 415 to generate the reconstructed current image block. The reconstructed current image block is a proxy of the corresponding block of the media frame that a video decoder generates when decoding the video stream generated by video encoder 400. Reconstruction unit 440 transmits the reconstructed block to the requesting row control unit 415.

Filter 445 performs one or more filtering techniques for the blocks included in the block rows encoded by row control units 415(0), 415(1), 415(2), . . . , 415(N−1). More specifically, filter 445 performs one or more filtering techniques in response to receiving a request from a row control unit 415 to process a specified block. The one or more filtering techniques can include deblocking filtering, sample adaptive offset filtering, and/or the like. With deblocking filtering, filter 445 improves the visual quality of the reconstructed current block of the media frame by smoothing the sharp edges resulting from the transformation and/or quantization performed by rate-distortion optimization unit 435 during encoding followed by the inverse quantization and/or inverse transformation performed by reconstruction unit 440 during reconstruction. With sample adaptive offset filtering, filter 445 further filters the reconstructed current block of the media frame by selectively adding offsets to the pixel values of the reconstructed current block of the media frame based on the pixel value of a given pixel and/or the pixel values of one or more neighbor pixels. Filter 445 transmits the filtered block to the requesting row control unit 415.

Engine memory system 450, including direct memory access engines 455, shared memory 460, and cache memory 465, can communicate with other components of video encoder 400 including, without limitation, row control units 415(0), 415(1), 415(2), . . . , 415(N−1), motion estimation unit 425, intra search unit 430, rate-distortion optimization unit 435, reconstruction unit 440, and filter 445. Shared memory 460 can store data and/or commands for use by row control units 415(0), 415(1), 415(2), . . . , 415(N−1), motion estimation unit 425, intra search unit 430, rate-distortion optimization unit 435, reconstruction unit 440, and/or filter 445. Cache memory 465 can store short term data and/or commands that have been recently accessed by, or is predicted to soon be accessed by, row control units 415(0), 415(1), 415(2), . . . , 415(N−1), motion estimation unit 425, intra search unit 430, rate-distortion optimization unit 435, reconstruction unit 440, and/or filter 445. The data and/or commands stored in cache memory 465 can be a copy of data and/or commands stored in another memory including, without limitation, shared memory 460, PP memory 204, system memory 104, and/or the like. Typically, access times to load data from and/or store data to cache memory 465 is lower than loading data from and/or storing data to these other memories. DMA engines 455 can perform block copies of data and/or commands from one location in memory to another location in memory. More specifically, DMA engines 455 can copy a block of data and/or commands within a particular memory or between one memory and another memory. Therefore, DMA engines 455 can copy a block of data and/or commands within or between any one or more of shared memory 460, PP memory 204, system memory 104, and/or the like.

In some embodiments, row control units 415 can share data and/or commands with one another and/or with other functional units of video encoder 400 via shared memory 460. In such embodiments, a row control unit 415 can store motion vector data, neighbor pixel data, reconstruction data, commands, and/or the like. Row control unit 415 can transmit a trigger command to an appropriate functional unit along with the address in shared memory where the corresponding data and/or commands are stored. Subsequent to performing one or more operations in response to the trigger command, the appropriate functional unit can transmit to the requesting row control unit 415 the address in shared memory where the corresponding result data is stored.

As row control units 415(0), 415(1), 415(2), . . . , 415(N−1) complete encoding of the blocks in each block row, with assistance from the other functional units, row control units 415(0), 415(1), 415(2), . . . , 415(N−1) store the encoded blocks in an appropriate location in frame buffer memory via frame buffer interface 470. Entropy encoder 475 monitors frame buffer memory via frame buffer interface 470 to determine when each encoded block is stored in frame buffer memory. From these encoded blocks stored in frame buffer memory, entropy encoder 475 generates the final encoded bitstream for video encoder 400. In some embodiments, entropy encoder 475 generates the final encoded bitstream, that is, the output video stream, using a lossless compression technique. Additionally or alternatively, entropy encoder 475 generates the final encoded bitstream using a lossy compression technique. To facilitate sequential block entropy encoding, row control units 415(0), 415(1), 415(2), . . . , 415(N−1) store the final winning candidate data into frame buffer memory. Entropy encoder 475 encodes the blocks of a media frame sequentially in raster scan order. In so doing, entropy encoder 475 waits for the final winning candidate data for each sequential block to be stored in frame buffer memory prior to encoding the bit stream for that block. In this manner, entropy encoder 475 encodes the blocks of each block row of the image sequentially and one at a time in raster scan order. In raster scan order, entropy encoder 475 encodes blocks on each block row of the media frame from left to right and encodes the block rows of the media frame from top to bottom.

As described herein, row control units 415(0), 415(1), 415(2), . . . , 415(N−1) included in row control unit array 410 can encode up to N block rows of the media frame concurrently. In cases where the media frame includes a total of N block rows, row control units 415(0), 415(1), 415(2), . . . , 415(N−1) can encode the media frame in a single pass. More commonly, the number of block rows in the media frame exceeds the number of row control units 415. In such cases, video encoder 400 divides the media frame into multiple groups of N block rows each. A first group of block rows includes the topmost N rows of the media frame. A second group of block rows includes the second topmost N rows of the media frame. A third group of block rows includes the third topmost N rows of the media frame, and so on. Row control units 415(0), 415(1), 415(2), . . . , 415(N−1) encode the media frame by groups, such that row control units 415(0), 415(1), 415(2), . . . , 415(N−1) encode the first group of block rows concurrently, followed by the second group of block rows concurrently, followed by the third group of block rows concurrently, and so on.

As each row control unit 415 completes encoding of the blocks for the corresponding block row of the first group of N block rows, the row control unit 415 can begin encoding of a block row of a second group of N block rows. For example, when row control unit 415(0) completes encoding of the blocks for an assigned block row in the first group of N block rows, row control unit 415(0) can begin encoding of the blocks for a corresponding block row in the second group of N block rows. Likewise, when each of row control units 415(1), 415(2), . . . , 415(N−1) completes encoding of the blocks for the assigned block row in the first group of N block rows, row control units 415(1), 415(2), . . . , 415(N−1) can begin encoding of the blocks for a corresponding block row in the second group of N block rows, respectively. This process continues for each group of N block rows until all of the block rows for the current media frame have been encoded. In some embodiments, the total number of block rows in the current media frame may not be divisible by N. In such embodiments, the final group of block rows to encode for media frame may include fewer than N block rows. As a result, less than all of the N row control units 415 may be operable when encoding the final group of block rows.

In some embodiments, video encoder 400 can include feedback loops from a later stage to an earlier stage. For example, the visual quality of the output video stream can be improved with a feedback loop from rate-distortion optimization unit 435 to motion estimation unit 425. With such a feedback loop, motion estimation unit 425 can generate a motion vector for the current block based on pixel data from the current block as well as the motion vector from the prior block, resulting in improved motion estimation. Such a feedback loop can cause delay, where a row control unit 415 waits for completion of processing of a current block by rate-distortion optimization unit 435 before motion estimation for the next block can be performed by motion estimation unit 425. With one operable row control unit 415, this delay from the feedback loop can cause a decrease in performance and utilization because one or more functional units are not accessed by the one operable row control unit 415.

By contrast, when multiple row control units 415 are operable, a particular row control unit 415 can be delayed, such as the delay resulting from the rate-distortion optimization unit 435 to motion estimation unit 425 feedback loop delay. However, while the particular row control unit 415 is not accessing one or more functional units due to the delay, other row control units 415 that are encoding blocks for other block rows can access the one or more functional units. As a result, utilization of the one or more functional units is increased, leading to improved performance.

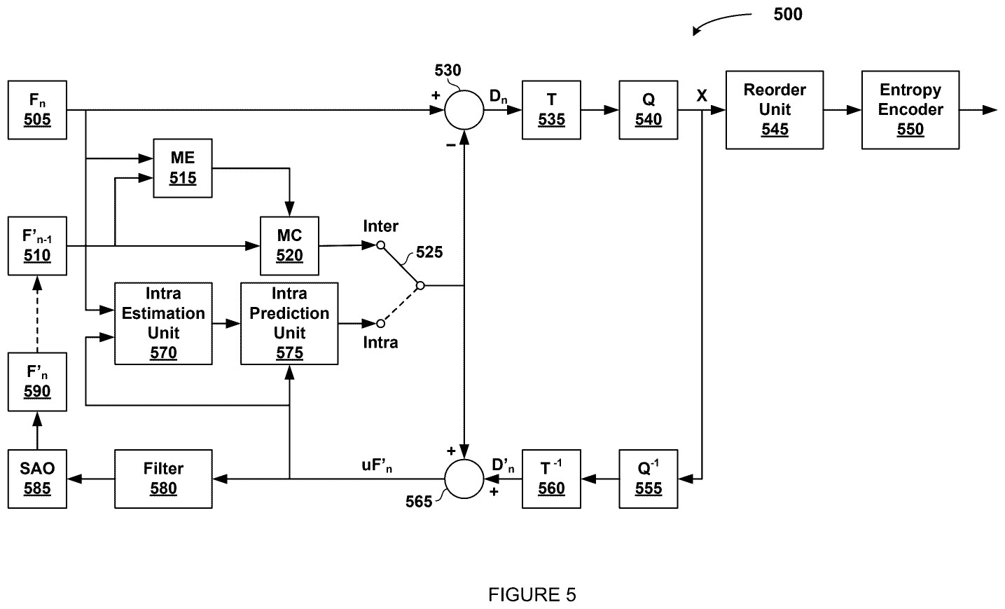

FIG. 5 illustrates a functional view of a video encoder 500 that can encode a media frame for the computing system 100 of FIGS. 1-4, according to various embodiments. The video encoder 500 can encode a video stream compatible with the high efficiency video coding (HEVC) standard also known as H.265 or motion picture experts group high efficiency (MPEG-H) Part 2. Additionally or alternatively, the video encoder 500, as is and/or with slight modification, can encode a video stream compatible with any other technically feasible video encoding standard. Such additional and/or alternative video encoding standards can include, without limitation, H.264,H.266, Video comPression format 9 (VP9), Alliance for Open Media (AOMedia) Video 1 (AV1), and/or the like.

As shown, the video encoder 500 receives an input media frame to be encoded. This received media frame is referred to as the current media frame (Fₙ) 505. The current media frame (Fₙ) 505, and other media frames processed by video encoder 500, is divided into multiple blocks, referred to as macroblocks, coding tree units (CTUs), and/or the like. Each block includes a group of neighboring pixels, such as an 8×8 block of pixels, a 16×16 block of pixels, and/or the like. Each block is further divided into partitions, where each partition includes luminance pixels (luma pixels) and/or chrominance pixels (chroma pixels). Luma pixels include the luma, or Y, pixel values for the pixels in the block. Chroma pixels include the chroma pixel values for the pixels in the block. Chroma pixel values are typically color difference values and can be of two types: (1) red color difference (U or Cᵣ) pixel values; and (2) blue color difference (V or C_{b}) pixel values.

The video encoder 500 also includes a reconstructed media frame based on the previously received and encoded media frame. This reconstructed media frame is referred to as the reference media frame (F′ₙ₋₁) 510. Based on the current pixels in the current media frame (Fₙ) 505 and on the reference pixels in the reference media frame (F′ₙ₋₁) 510, motion estimation unit (ME) 515 generates a motion vector for the current block that is predictive of the block of the current media frame from the corresponding block of the reference media frame. The video encoder 500 can use the motion vector as an interframe candidate. Motion estimation unit 515 transmits the interframe candidate to motion compensation unit (MC) 520. Motion compensation unit 520 generates motion compensated pixels for the interframe candidate. Motion compensation unit 520 transmits the motion compensated pixels for the interframe candidate to the “inter” input of selector 525.

In addition, based on the current pixels in the current media frame (Fₙ) 505 and on the neighboring pixels of the reconstructed current media frame uF′ₙ received from summer 565, intra estimation unit 570 selects an intra prediction mode. In some embodiments, intra estimation unit 570 can select the intra prediction mode that best predicts the pixels of the current block. Intra estimation unit 570 can select the intra prediction mode that results in the lowest rate-distortion cost value based on the sum of square errors (SSE) distortion for the current block as determined by the rate-distortion optimization unit of selector 525. The number and type of available prediction modes can vary based on the block size. For example, the number and type of available prediction modes can be different among 4×4 pixel blocks, 8×8 pixel blocks, 16×16 pixel blocks, 32×32 pixel blocks, and/or the like. In that regard, intra estimation unit 570 can select different prediction modes for each of the possible block sizes based on what prediction mode results in lowest rate-distortion cost value determined by the rate-distortion optimization unit for the respective block size. Further, intra estimation unit 570 can select different prediction modes for the luma values in the block versus the chroma samples in the block. In some embodiments, the prediction mode determines the order that the pixels in the current block are scanned to generate the predicted intraframe candidate. For example, the prediction mode can specify vertical scanning, horizontal scanning, diagonal down-left scanning, diagonal down-right scanning, vertical left scanning, vertical right scanning, horizontal down scanning, horizontal up scanning, and/or the like.

Based on the selected intra prediction mode, intra prediction unit 575 generates an intraframe candidate. Intra prediction unit 575 scans the pixel values in the current block in the order specified by the selected intra prediction mode. For each scanned pixel, intra prediction unit 575 determines a predicted pixel value based on differences between the pixel value and the pixel values of pixels that neighbor the pixel. From the predicted pixel values, intra prediction unit 575 generates the intraframe candidate. Intra prediction unit 575 transmits the intraframe candidate to the “intra” input of selector 525.

Selector 525 determines whether to select the compensated pixels for the interframe candidate received from motion compensation unit 520 or the intraframe candidate received from intra prediction unit 575. The determination of selecting the interframe candidate or the intraframe candidate can occur at any level of granularity, including, without limitation, on a block by block basis, on a media frame by media frame basis, and/or the like. The technique for determining whether to select the interframe candidate or the intraframe candidate can be relatively simple or relatively complex. Typically, the more complex the technique used to determine whether to select the interframe candidate or the intraframe candidate, the higher the video quality of the resulting encoded stream. The selected candidate between the interframe candidate and the intraframe candidate is referred to as the winning candidate. In some embodiments, selector 525 determines the winning candidate based solely on luma pixel values. In some embodiments, selector 525 determines the winning candidate based on both luma pixel values and chroma pixel values. In general, basing the selection on both luma pixel values and chroma pixel values can be more accurate, and therefore result in higher visual quality, than basing the selection on luma pixel values alone.

In some embodiments, when selecting the winning candidate, selector 525 can also perform rate-distortion optimization (RDO). The rate-distortion optimization unit (not shown in FIG. 5) of selector 525 receives the interframe candidate and the intraframe candidate. The rate-distortion optimization unit further receives the reconstructed pixels of the reconstructed current media frame uF′ₙ received from inverse quantization unit 555, inverse transform unit 560, and summer 565. Based on the reconstructed pixels of the reconstructed current media frame uF′ₙ, the rate-distortion optimization unit determines a rate-distortion cost value based on the sum of square errors (SSE) distortion for the current block. Selector 525 selects the winning candidate based at least in part on the rate-distortion cost value for the current block as determined by the rate-distortion optimization unit. Selector 525 transmits the winning candidate to summer 530 and summer 565.

Summer 530 inverts the winning candidate received from selector 525 before combining the winning candidate with current media frame (Fₙ) 505. As a result, summer 530 determines the difference resulting from subtracting the winning candidate from current media frame (Fₙ) 505. This difference is referred to as residue pixels or, more generally, the residue Dₙ. Summer 530 transmits the residue Dₙ to transform unit (T) 535.

Transform unit 535 converts the residue Dₙ received from summer 530 into an array of frequency coefficients that represent the image portion included in each block. Transform unit 535 transmits the frequency coefficients to quantization unit (Q) 540. Quantization unit 540 reduces the total number of unique frequency coefficients received from transform unit 535 by quantizing the frequency coefficients according to defined frequency ranges or bins. Quantization unit 540 transmits the quantized frequency coefficients X to reorder unit 545. Reorder unit 545 sorts the quantized frequency coefficients X in order of decreasing value, such that all coefficients with a value of zero (‘0’) are sorted to be at the end of the set of frequency coefficients. Reorder unit 545 transmits the sorted quantized frequency coefficients to entropy encoder 550. Entropy encoder 550 generates the final encoded bitstream for video encoder 500. In some embodiments, entropy encoder 550 generates the final encoded bitstream, that is, the output video stream, using a lossless compression technique. Additionally or alternatively, entropy encoder 550 generates the final encoded bitstream using a lossy compression technique. The final encoded bitstream generated by video encoder 500 can be subsequently decoded by a corresponding video decoder (not shown).

In addition to transmitting the quantized frequency coefficients X to reorder unit 545, quantization unit 540 transmits the quantized frequency coefficients X to inverse quantization unit (Q⁻¹) 555. Inverse quantization unit 555 performs an inverse quantization function to reverse the quantization performed by quantization unit 540.

Inverse quantization unit 555 transmits the inverse quantized frequency coefficients to inverse transform unit (T⁻¹) 560. Inverse transform unit 560 performs an inverse transformation function to reverse the transformation performed by transform unit 535. In so doing, inverse transform unit 560 generates reconstructed residue D′ₙ. Inverse transform unit 560 transmits the reconstructed residue D′ₙ to summer 565.

Summer 565 adds the reconstructed residue D′ₙ to the winning candidate generated by selector 525 to generate the reconstructed current media frame uF′ₙ. The reconstructed current media frame uF′ₙ is a proxy of the media frame that a video decoder generates when decoding the video stream generated by video encoder 500. As described herein, summer 565 transmits the reconstructed current media frame uF′ₙ to intra estimation unit 570 to generate the intraframe candidate in conjunction with intra prediction unit 575. In addition, summer 565 transmits the reconstructed current media frame uF′ₙ to filter 580. In some embodiments, filter 580 is a deblocking filter that improves the visual quality of the reconstructed current media frame uF′ₙ. Filter 580 improves visual quality by smoothing the sharp edges resulting from the transformation performed by transform unit 535 and/or the quantization performed by quantization unit 540 followed by the inverse quantization performed by inverse quantization unit 555 and/or the inverse transformation performed by inverse transform unit 560. Filter 580 transmits the filtered image to sample adaptive offset filter (SAO) 585. Sample adaptive offset filter 585 further filters the reconstructed current media frame uF′ₙ by selectively adding offsets to the pixel values of the reconstructed current media frame uF′ₙ based on the pixel value of a given pixel and/or the pixel values of one or more neighbor pixels. Sample adaptive offset filter 585 stores the SAO filtered image as the final reconstructed current media frame (F′ₙ) 590.

After video encoder 500 completes processing of the current media frame (Fₙ) 505, video encoder 500 receives the next input media frame, which then becomes the new current media frame (Fₙ) 505. Further, the reconstructed current media frame (F′ₙ) 590 becomes the new reference media frame (F′ₙ₋₁) 510. Video encoder 500 uses this new reference media frame (F′ₙ₋₁) 510 to generate the inter candidate for the new current media frame (Fₙ) 505.

In some embodiments, the visual quality of the output video stream can be further improved with a feedback loop (not shown) from selector 525 to motion estimation unit 515. Upon selecting the winning candidate, selector 525 determines the final motion vector for the current block. Selector 525 transmits the final motion vector for the current block to motion estimation unit 515. Motion estimation unit 515 can use this final motion vector for the current block to generate the motion vector for the next block. In this manner, motion estimation unit 515 can generate a motion vector for the current block based on pixel data from the current block as well as the motion vector from the prior block, resulting in improved motion estimation. This improved motion estimation, in turn, can result in improved motion compensation as performed by motion compensation unit 520 and improved selection accuracy as performed by selector 525.

In some embodiments, a given block can include multiple subblocks or partitions. The subblocks can have various sizes. For example, a 16×16 pixel block can include 8×16 pixel subblocks, 16×8 pixel subblocks, 8×8 pixel subblocks, and/or the like, in any combination. In such embodiments, motion estimation unit 515 can generate a motion vector for each subblock and combine the motion vectors from the various subblocks to generate a final motion vector for the block.

In some embodiments, video encoder 500 can be implemented with the architecture of video encoder 400 of FIG. 4. In such embodiments, media frames, including, without limitation, current media frame (Fₙ) 505, reference media frame (F′ₙ₋₁) 510, and reconstructed current media frame (F′ₙ) 590, can be stored in any technically feasible memory. More specifically, these media frames can be stored in shared memory 460, cache memory 465, frame buffer memory, and/or the like. Motion estimation unit 515 and/or motion compensation unit 520 can represent, without limitation, motion estimation unit 425 of FIG. 4. Intra estimation unit 570 and/or intra prediction unit 575 can represent, without limitation, intra search unit 430 of FIG. 4. One or more of selector 525 (including the rate-distortion optimization unit of selector 525), summer 530, transform unit 535, and/or quantization unit 540 can represent, without limitation, rate-distortion optimization unit 435 of FIG. 4. Inverse quantization unit 555, inverse transform unit 560, and/or summer 565 can represent, without limitation, reconstruction unit 440 of FIG. 4.

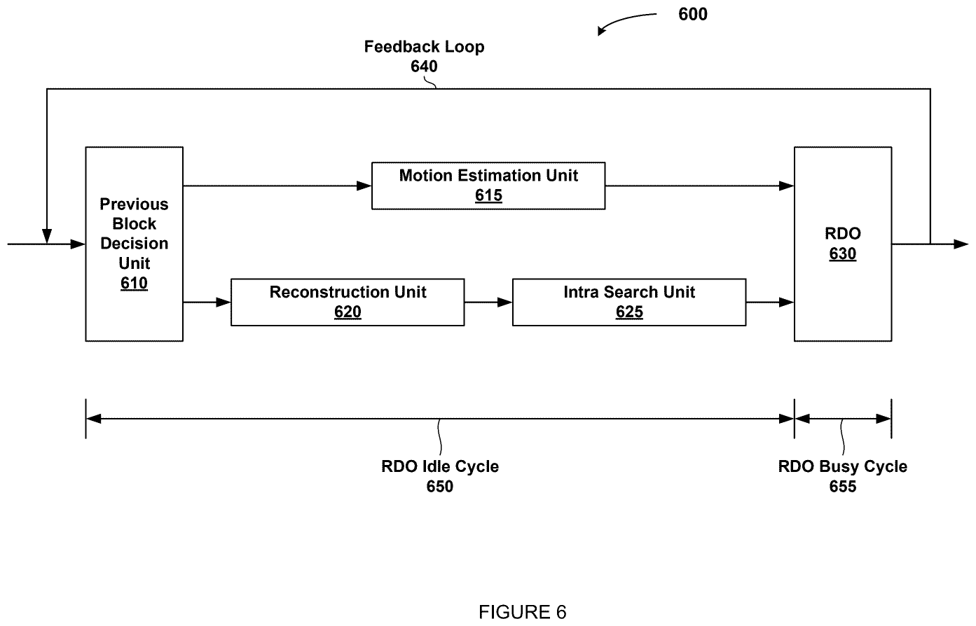

FIG. 6 is a block diagram of a video encoder 600 configured for sequential video encoding that can be implemented in the computing system 100 of FIG. 1, according to various embodiments. As shown, the video encoder 600 includes, without limitation, a previous block decision unit 610, a motion estimation unit 615, a reconstruction unit 620, an intra search unit 625, and a rate-distortion optimization unit (RDO) 630.

Previous block decision unit 610 can represent, without limitation, the inputs for generating an interframe candidate and an intraframe candidate for a current block based on the output from encoding the prior block. These inputs include the reconstructed media frame based on the previously received and encoded media frame. This reconstructed media frame is used as the reference media frame to generate the interframe candidate for the current block. These inputs further include the reconstructed media frame based on the current frame which provides the neighbor pixel data used to generate the intraframe candidate for the current block.

Motion estimation unit 615 can represent, without limitation, motion estimation unit 425 of FIG. 4, the combination of motion estimation unit 515 and motion compensation unit 520 of FIG. 5, and/or the like. Motion estimation unit 615 generates an interframe candidate for the current block being encoded by video encoder 600. Motion estimation unit 615 transmits the interframe candidate to rate-distortion optimization unit 630.

Reconstruction unit 620 can represent, without limitation, reconstruction unit 440 of FIG. 4, the combination of inverse quantization unit 555, inverse transform unit 560, and summer 565 of FIG. 5, and/or the like. Reconstruction unit 620 generates a reconstructed media frame based on the current image block being encoded. The reconstructed media frame provides neighbor pixel data for generating an intraframe candidate. Reconstruction unit 620 transmits the reconstructed media frame to intra search unit 625.

Intra search unit 625 can represent, without limitation, intra search unit 430 of FIG. 4, the combination of intra estimation unit 570 and intra prediction unit 575 of FIG. 5, and/or the like. Intra search unit 625 generates an intraframe candidate for the current block being encoded by video encoder 600 based on the reconstructed media frame received from reconstruction unit 620. Intra search unit 625 transmits the intraframe candidate to rate-distortion optimization unit 630.

Rate-distortion optimization unit 630 can represent, without limitation, rate-distortion optimization unit 435 of FIG. 4, selector 525 (including the rate-distortion optimization unit of selector 525) of FIG. 5, and/or the like. Rate-distortion optimization unit 630 receives the interframe candidate from motion estimation unit 615 and the intraframe candidate from intra search unit 625. Rate-distortion optimization unit 630 further receives the reconstructed pixels of the reconstructed current media frame from reconstruction unit 620. Based on the reconstructed pixels of the reconstructed current media frame, rate-distortion optimization unit 630 determines a rate-distortion cost value based on the sum of square errors (SSE) distortion for the current block. Rate-distortion optimization unit 630 selects the winning candidate based at least in part on the rate-distortion cost value for the current block as determined by the rate-distortion optimization unit.

The inputs to previous block decision unit 610 are dependent on a feedback loop 640 from the output of rate-distortion optimization unit 630 to the input of previous block decision unit 610. This feedback loop 640 allows for improved visual quality when generating the interframe candidate and/or the intraframe candidate and for selecting between the interframe candidate and the intraframe candidate. However, this feedback loop 640 can also cause delay when encoding a current block based on data generating during encoding of the current block and/or the prior block. This delay is represented by RDO idle cycle 650, during which rate-distortion optimization unit 630 is waiting for the interframe candidate from motion estimation unit 615 and/or for the intraframe candidate from intra search unit 625. After rate-distortion optimization unit 630 receives the interframe candidate from motion estimation unit 615 and/or the intraframe candidate from intra search unit 625, rate-distortion optimization unit 630 performs the functions described herein during the RDO busy cycle 655. The delay represented by RDO idle cycle 650 can be eliminated by removing the feedback loop 640 but removing the feedback loop 640 can result in an undesirable loss of visual quality of the generated video stream.

In some embodiments, video encoders 400, 500, 600 of FIGS. 4-6 can include other feedback loops and sources of delay. In general, when one row control unit 415 is operational, these feedback loops and other sources of delay can lead to underutilization and reduced performance of various functional units of video encoders 400, 500, 600. By contrast, when multiple row control units 415 are operational, delays from feedback loops and/or other sources that are sustained by one row control unit 415, can be mitigated by the operation of other row control units 415 that are not currently delayed. In this manner, any row control unit 415 can access the various functional units of video encoders 400, 500, 600 without regard to delays sustained by one or more other row control units 415.

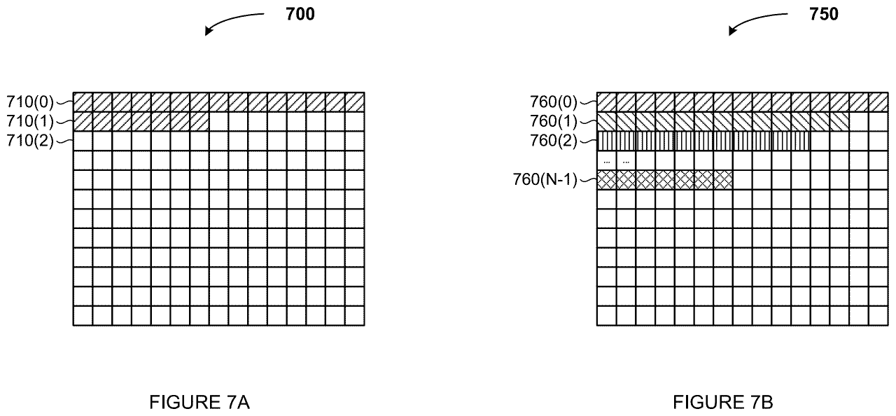

FIGS. 7A-B illustrate how blocks of a media frame are encoded by the video encoders 400, 500, 600 of FIGS. 4-6, according to various embodiments. As shown in FIG. 7A, a video encoder can encode the block rows 710 of a media frame 700 sequentially, such as when a single row control unit 415 of video encoder 400 is operating. When encoding block rows 710 sequentially, the video encoder encodes the blocks of each block row 710 one at a time in raster scan order. In raster scan order, the video encoder encodes blocks on each block row 710 of media frame 700 from left to right and encodes the block rows 710 of media frame 700 from top to bottom. The video encoder first encodes block row 710(0) by encoding the leftmost block, followed by encoding the second block from the left, and continuing to encode blocks one at a time until encoding of the rightmost block is complete. After encoding all of the blocks in block row 710(0), the video encoder proceeds with encoding block row 710(1) by encoding the leftmost block, followed by encoding the second block from the left, and continuing to encode blocks one at a time until encoding of the rightmost block is complete. After encoding all of the blocks in block row 710(1), the video encoder proceeds with encoding block row 710(2) and the remaining block rows 710 in like manner until all of the block rows 710 of media frame 700 are encoded.

As shown in FIG. 7B, a video encoder can encode the block rows 760 of a media frame 750 in parallel, such as when a multiple row control units 415 of video encoder 400 are operating. When encoding block rows 760 in parallel, a video encoder that includes N row control units 415 can encode the blocks of up to N block rows 760 in parallel. In particular, the video encoder can encode the blocks of block row 760(0), the blocks of block row 760(1), the blocks of block row 760(2), and so on, through the blocks of block row 760(N−1) in parallel. When encoding the blocks of a particular block row 760, the video encoder can incorporate data from a neighboring block in the same block row 760 and/or from the prior block row 760. For example, to encode the rightmost shaded block on block row 760(1), the video encoder can incorporate data, such as pixel data, motion vector data, and/or the like, from the neighboring block to the left of the current block on the same block row 760(1). Additionally or alternatively, the video encoder can incorporate data, such as pixel data, motion vector data, and/or the like, from one or more neighboring blocks of the current block on the prior block row 760(0), such as the block directly above, the block above and to the left, and/or the block above and to the right of the current block. As a result, when row control unit 415(1) is encoding a block in block row 760(1), row control unit 415(1) waits until row control unit 415(0) has encoded the relevant neighbor blocks in block row 760(0). Likewise, when row control unit 415(2) is encoding a block in block row 760(2), row control unit 415(2) waits until row control unit 415(1) has encoded the relevant neighbor blocks in block row 760(1), and so on. In this manner, even though multiple row control units 415 are encoding blocks for multiple block rows 760 in parallel, the multiple row control units 415 can be encoding blocks in different left-to-right positions in the respective block rows 760.

As each row control unit 415 completes encoding of the blocks for the corresponding block row 760 of the first group of N block rows, the row control unit 415 can begin encoding of a block row 760 for a second group of N block rows. For example, when row control unit 415(0) completes encoding of the blocks for block row 760(0), row control unit 415(0) can begin encoding of the blocks for block row 760(N) (not shown). Likewise, when row control unit 415(1) completes encoding of the blocks for block row 760(1), row control unit 415(1) can begin encoding of the blocks for block row 760(N+1) (not shown). Similarly, when row control unit 415(2) completes encoding of the blocks for block row 760(2), row control unit 415(2) can begin encoding of the blocks for block row 760(N+2) (not shown), and so on. This process continues for each group of N block rows 760 until all of the block rows 760 for media frame 750 have been encoded. In some embodiments, the total number of block rows in media frame 750 may not be divisible by N. In such embodiments, the final group of block rows 760 to encode for media frame 750 may include fewer than N block rows 760. As a result, less than all of the N row control units 415 may be operable when encoding the final group of block rows 760.

It will be appreciated that the system shown herein is illustrative and that variations and modifications are possible. The techniques described herein can be performed by one or more alternative accelerators including, without limitation, CPUs, GPUs, video encoders, DMA units, IPUs, NPUs, TPUs, NNPs, DPUs, VPUs, ASICs, FPGAs, and/or the like, in any combination. More generally, the techniques described herein can be applied to any CPU 102, PPU 202, video encoder, and/or any other processing unit in any combination.

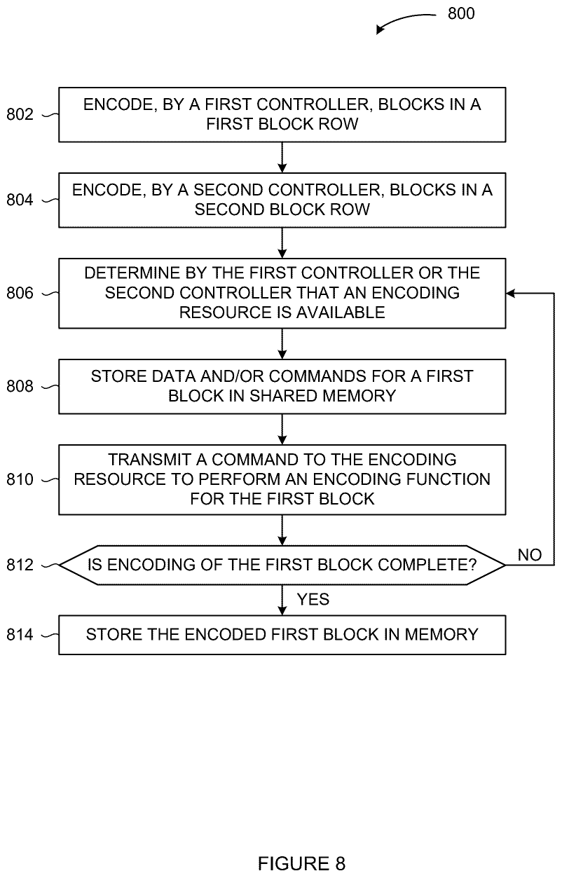

FIG. 8 is a flow diagram of method steps for parallel encoding of multiple block rows in the computing system of FIGS. 1-7B, according to various embodiments. Additionally or alternatively, the method steps can be performed by one or more alternative accelerators including, without limitation, CPUs, GPUs, DMA units, IPUs, NPUs, TPUs, NNPs, DPUs, VPUs, ASICs, FPGAs, and/or the like, in any combination. Although the method steps are described in conjunction with the systems of FIGS. 1-7B, persons of ordinary skill in the art will understand that any system configured to perform the method steps, in any order, is within the scope of the present disclosure.

As shown, a method 800 begins at step 802, where a first controller, such as a first one of the control units 415 of FIG. 4, encodes blocks in a first block row of a media frame. At step 804, where a second controller, such as a second one of the control units 415 of FIG. 4, encodes blocks in a second block row of the media frame. The first controller encodes the first plurality of blocks concurrently with the second controller encoding the second plurality of blocks. Depending on the video encoding standard, the blocks included in the first block row and the second block row can be macroblocks, coding tree units (CTUs), and/or the like. More generally, the first controller and the second controller are two controllers in a set of N controllers that are included in a row control unit array. Each of the N controllers encodes a different block row in a group of N block rows of a media frame.

At step 806, the first controller or the second controller determines that an encoding resource is available for performing an encoding function for a first block, where the first block is included in the first block row or the second block row, respectively. The encoding resource is one of a number of functional units included in the video encoder that also includes the first controller and the second controller. Each of the controllers has concurrent access to these various functional units of the video encoder. These other functional units include, without limitation, a motion estimation unit, an intra search unit, a rate-distortion optimization unit, a reconstruction unit, and a filter.

At step 808, to access the various functional units of the video encoder, the first controller or the second controller stores commands and/or data pertaining to the first block being encoded in shared memory. This shared memory can be any memory that is accessible to the controllers included in the row control unit array as well as to various other functional units of the video encoder.

At step 810, to access the various functional units of the video encoder, the first controller or the second controller transmits a command to the encoding resource, where the command triggers the encoding resource to perform an encoding function for the first block. In response to receiving the command, the encoding resource performs an encoding function. The encoding resource and encoding function can be any resource and function that performs one or more steps to encode the first block.

In that regard, the encoding resource can be a motion estimation unit. The encoding function can include generating a motion vector for a first block included in the first plurality of blocks. The motion vector can be an interframe candidate for the first block. The encoding function can further include generating motion compensated pixels for the interframe candidate based on the motion vector.

Additionally or alternatively, the encoding resource can be an intra search unit. The encoding function can include selecting an intra prediction mode based on pixel data included in a first block included in the first plurality of blocks and pixel data from neighboring pixels include in a reconstructed media frame of the media frame.

The encoding function can further include generating an intraframe candidate based on the selected intra prediction mode.

Additionally or alternatively, the encoding resource can be a rate-distortion optimization unit. The encoding function can include selecting a winning candidate for a first block included in the first plurality of blocks between an interframe candidate for the first block generated by a motion estimation unit and an intraframe candidate for the first block generated by an intra search unit. The encoding function of selecting the winning candidate for the first block can include determining a rate-distortion cost value based on a sum of square errors (SSE) distortion for the first block; and selecting the winning candidate based at least in part on the rate-distortion cost value.

Additionally or alternatively, the encoding resource can be a reconstruction unit. The encoding function can include generating frequency coefficients by performing an inverse quantization function to reverse a quantization previously performed on a first block included in the first plurality of blocks. The encoding function can further include generating reconstructed residue data by performing an inverse transformation function to reverse a transformation previously performed on the first block. The encoding function can further include summing the reconstructed residue data with one of an interframe candidate for the first block or an intraframe candidate for the first block to generate a reconstructed block of the first block.

Additionally or alternatively, the encoding resource can be a filter unit. The encoding function can include filtering the first block using at least one of a deblocking filter, a sample adaptive offset filter, and/or the like.

At step 812, the first controller or the second controller determines whether encoding of the first block is complete. Encoding of the first block is not complete when at least one encoding function has not yet been performed by the corresponding encoding resource. If encoding of the first block is not complete, then the method 800 returns to step 806, described above. Encoding of the first block is complete when the various encoding functions performed by the various encoding resources are complete and the first block is ready for entropy encoding. If the encoding of the first block is complete, then the method 800 proceeds to step 814.

At step 814, the first controller or the second controller stores the encoded first block in memory. The memory can be any suitable memory including, without limitation, frame buffer memory, PP memory 204, system memory 104, and/or the like. Subsequent to storing the encoded first block in shared memory, an entropy encoder generates a bitstream from the encoded first block. The entropy encoder encodes the blocks of a media frame sequentially in raster scan order. In so doing, the entropy encoder waits for the final winning candidate data for each sequential block to be stored in memory prior to encoding the bit stream for that block. In this manner, the entropy encoder encodes the blocks of each block row of the image sequentially and one at a time in raster scan order. In raster scan order, the entropy encoder encodes blocks on each block row of the media frame from left to right and encodes the block rows of the media frame from top to bottom. The method 800 then terminates. Alternatively, the method 800 proceeds to step 802, described above, to process additional blocks in the block rows and additional block rows in the media frame.

In sum, various embodiments include techniques for parallel encoding of multiple block rows by a video encoder included in a computing system. As described herein, an improved video encoder processes block rows in a media frame as parallel units. The video encoder assigns and schedules each hardware control unit in a set of multiple control unit to encode a different block row. For a video encoder with N control units, the row control units can encode N block rows concurrently. The video encoder operates such that a preceding block row is encoded before a subsequent block row at least to the point where the block currently being encoded for the subsequent block row can access the needed information for neighboring pixels included in blocks of the preceding block row. This approach allows the row control unit for the subsequent block row to utilize the encoding information from the top neighbor block row being encoded by a different row control unit. Within a given block, the row control unit can encode the various partitions of the block sequentially. In this manner, the video encoder enables access by the row control units to neighbor partition information, thereby achieving high video encoding quality.

The row control units performing parallel encoding of block rows share other hardware computational resources of the video encoder including motion estimation, intra search, rate distortion optimization, reconstruction, and filtering. As a result, if one row control unit is waiting internally due to partition dependencies, and therefore does not utilize other hardware computational resources, then other row control units encoding partitions for other block rows can utilize these other hardware computational resources. This parallelism across multiple block rows can better leverage these other hardware computational resources, thereby enhancing utilization and efficiency of the hardware computational resources of the video encoder. Further, the performance of this approach can by further enhanced by adding more row control units in order to encode more block rows in parallel. In this manner, the performance increase with the disclosed techniques is scalable as a function of the number of row control units. At the same time, encoding multiple block rows in parallel can achieve almost the same quality as sequential encoding, but with significantly increased performance.

With this approach, each row control unit included in a hardware video encoder is responsible for encoding a different block row of a media frame included in a video stream. The multiple row control units manage the parallelism and synchronization between the block rows being concurrently encoded. Further, the multiple row control units manage access to various other hardware computational resources included in the video encoder. These hardware computational resources are capable of handling computation requests from different row control units that are encoding partitions across various block rows.

At least one technical advantage of the disclosed techniques relative to the prior art is that, with the disclosed techniques, a video encoder includes multiple row control units that encode multiple rows of partitions in the media frame in parallel. Further, various other hardware computational resources included in the video encoder are available in parallel to the row control units. Therefore, each row control unit can access any idle functional units of the video encoder without waiting for other row control units to reach a particular stage of the video encoding process. As a result, parallel processing of block rows and utilization of other functional units of the video encoder is enhanced relative to prior convention approaches. These advantages represent one or more technological improvements over prior art approaches.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for parallel encoding of multiple block rows in a media frame, the method comprising:
encoding, by a first controller, a first plurality of blocks included in a first row of a media frame;
encoding, by a second controller in parallel with the first controller encoding the first plurality of blocks, a second plurality of blocks included in a second row of the media frame; and
accessing, by the second controller, a first hardware computational resource to perform a first video encoding function,
wherein the first hardware computational resource is concurrently accessible by the first controller and the second controller.

2. The computer-implemented method of claim 1, wherein the first controller encodes the first plurality of blocks concurrently with the second controller encoding the second plurality of blocks.

3. The computer-implemented method of claim 1, wherein the first hardware computational resource comprises a motion estimation unit, and wherein the first video encoding function comprises generating a motion vector for a first block included in the first plurality of blocks, and wherein the motion vector comprises an interframe candidate for the first block.

4. The computer-implemented method of claim 3, wherein the first video encoding function further comprises generating motion compensated pixels for the interframe candidate based on the motion vector.

5. The computer-implemented method of claim 1, wherein the first hardware computational resource comprises an intra search unit, and wherein the first video encoding function comprises selecting an intra prediction mode based on pixel data included in a first block included in the first plurality of blocks and pixel data from neighboring pixels include in a reconstructed media frame of the media frame.

6. The computer-implemented method of claim 5, wherein the first video encoding function further comprises generating an intraframe candidate based on the selected intra prediction mode.

7. The computer-implemented method of claim 1, wherein the first hardware computational resource comprises a rate-distortion optimization unit, and wherein the first video encoding function comprises selecting a winning candidate for a first block included in the first plurality of blocks between an interframe candidate for the first block generated by a motion estimation unit and an intraframe candidate for the first block generated by an intra search unit.

8. The computer-implemented method of claim 7, wherein selecting the winning candidate for the first block comprises:
determining a rate-distortion cost value based on a sum of square errors (SSE) distortion for the first block; and
selecting the winning candidate based at least in part on the rate-distortion cost value.

9. The computer-implemented method of claim 1, wherein the first hardware computational resource comprises a reconstruction unit, and wherein the first video encoding function comprises:
generating frequency coefficients by performing an inverse quantization function to reverse a quantization previously performed on a first block included in the first plurality of blocks; and
generating reconstructed residue data by performing an inverse transformation function to reverse a transformation previously performed on the first block.

10. The computer-implemented method of claim 9, wherein the first video encoding function further comprises:
summing the reconstructed residue data with one of an interframe candidate for the first block or an intraframe candidate for the first block to generate a reconstructed block of the first block.

11. The computer-implemented method of claim 1, wherein the first hardware computational resource comprises a filter unit, and wherein the first video encoding function comprises filtering a first block included in the first plurality of blocks using at least one of a deblocking filter or a sample adaptive offset filter.

12. The computer-implemented method of claim 1, further comprising, subsequent to encoding a first block included in the first plurality of blocks, storing the encoded first block in a shared memory, wherein an entropy encoder generates a bitstream from the encoded first block.

13. The computer-implemented method of claim 1, wherein the first plurality of blocks and the second plurality of blocks comprise at least one of macroblocks or coding tree units (CTUs).

14. The computer-implemented method of claim 1, wherein the first controller and the second controller are included in a plurality of encoders that are encoding a first group of rows of the media frame, wherein the first group of rows includes the first row and the second row, and further comprising:
determining, by the first controller, that encoding of the first plurality of blocks included in the first row of the media frame is complete; and
encoding, by the first controller, a third plurality of blocks included in a third row of the media frame,
wherein the third row is included in a second group of rows of the media frame.

15. The computer-implemented method of claim 14, further comprising:
determining, by the second controller, that encoding of the second plurality of blocks included in the second row of the media frame is complete; and
encoding, by the second controller, a fourth plurality of blocks included in a fourth row of the media frame,
wherein the fourth row is included in the second group of rows of the media frame.

16. The computer-implemented method of claim 1, wherein at least one of the first plurality of blocks or the second plurality of blocks is encoded according to any one or more of high efficiency video coding (HEVC) 264 standard (H.264), H.265, H.266, Video comPression format 9 (VP9), or Alliance for Open Media (AOMedia) Video 1 (AV1).

17. A computing system comprising:
a first controller that:
encodes a first plurality of blocks included in a first row of a media frame; and
a second controller that:
encodes a second plurality of blocks included in a second row of the media frame, and
accesses a first hardware computational resource to perform a first video encoding function,
wherein the first hardware computational resource is concurrently accessible by the first controller and the second controller.

18. The computing system of claim 17, wherein the first hardware computational resource comprises a motion estimation unit, and wherein the first video encoding function comprises:
generating a motion vector for a first block included in the first plurality of blocks, and wherein the motion vector comprises an interframe candidate for the first block; and
generating motion compensated pixels for the interframe candidate based on the motion vector.

19. The computing system of claim 17, wherein the first hardware computational resource comprises an intra search unit, and wherein the first video encoding function comprises:
selecting an intra prediction mode based on pixel data included in a first block included in the first plurality of blocks and pixel data from neighboring pixels include in a reconstructed media frame of the media frame; and
generating an intraframe candidate based on the selected intra prediction mode.

20. The computing system of claim 17, wherein:
the computing system further comprises a motion estimation unit and an intra search unit,
the first hardware computational resource comprises a rate-distortion optimization unit,
the first video encoding function comprises selecting a winning candidate for a first block included in the first plurality of blocks between an interframe candidate for the first block generated by the motion estimation unit and an intraframe candidate for the first block generated by the intra search unit, by:
determining a rate-distortion cost value based on a sum of square errors (SSE) distortion for the first block; and
selecting the winning candidate based at least in part on the rate-distortion cost value.
